(19) United States
(12) Patent Application Publication
(10) Pub. No.: US 2017/0373784 A1
(43) Pub. Date: Dec. 28, 2017

(54) OPTICAL TRANSMISSION APPARATUS AND WAVELENGTH CONTROL METHOD

(71) Applicant: FUJITSU LIMITED, Kawasaki-shi (JP)

(72) Inventor: Hiroyuki Irie, Kawasaki (JP)

(73) Assignee: FUJITSU LIMITED, Kawasaki-shi (JP)

(21) Appl. No.: 15/598,972

(22) Filed: May 18, 2017

(30) Foreign Application Priority Data
Jun. 23, 2016 (JP) 2016-124832

(51) Int. Cl. H04J 14/02; H04B 10/572; H04Q 11/00

(52) U.S. Cl. CPC H04J 14/0212; H04Q 11/0005; H04B 10/572; H04Q 2011/0016; H04Q 2011/0009

(57) ABSTRACT

An optical transmission apparatus includes a first transmitter configured to transmit a first optical signal in a first wavelength band and a second optical signal in a second wavelength band located next to the first wavelength band; a second transmitter configured to transmit a third optical signal in a third wavelength band located next to the second wavelength band and a fourth optical signal in a fourth wavelength band located next to the third wavelength band; and a processor coupled to the first transmitter and the second transmitter and configured to select the third wavelength band among the first wavelength band, the second wavelength band, the third wavelength band and the fourth wavelength band, and control the first wavelength band, the second wavelength band, and the fourth wavelength band based on the third wavelength band.

### CROSS-REFERENCE TO RELATED APPLICATION

This application is based upon and claims the benefit of priority of the prior Japanese Patent Application No. 2016-124832, filed on Jun. 23, 2016, the entire contents of which are incorporated herein by reference.

### FIELD

The embodiments discussed herein are related to an optical transmission apparatus and a wavelength control method.

### BACKGROUND

For example, there is provided a super channel that performs wavelength multiplexing on a plurality of sub-channels at high density using a wavelength division multiplexing (WDM) technique so as to output signals as if one signal. The super channel is a technique that transmits a signal, for example, at a data rate of 400 Gbps, 1 Tbps, or the like for each channel. The super channel includes a plurality of units, and a plurality of sub-carriers (SCs) are included for each unit. An optical node is capable of performing Add/Drop on a super channel entirely as a single wavelength channel using a wavelength selective switch (WSS), or the like.

A plurality of SCs are mountable in a unit in the super channel. However, if it is assumed that the absolute value of the wavelength of an SC has a tolerance of about ±2 GHz with respect to a set wavelength, the SC interval becomes a maximum of 4 GHz. As a result, when the SC interval in a unit becomes large, the frequency usage efficiency deteriorates. Thus, a method of controlling the wavelength of the SC in a unit is demanded so as to reduce the SC interval in the unit in order to increase the frequency usage efficiency. As the related art, for example, Japanese Laid-open Patent Publication No. 2014-217053, Japanese Laid-open Patent Publication No. 2014-217054, and Japanese Laid-open Patent Publication No. 2014-103600, and the like are disclosed.

However, if the SC interval in a unit is reduced, SCs in the unit overlap each other, and for example, a crosstalk arises between the SCs. Further, a pass band narrowing (PBN) penalty occurs at a WSS filter that transmits SCs in the unit. As a result, the transmission quality of the super channel deteriorates. In view of the above, it is desirable to reduce deterioration of the transmission quality of a super channel.

### SUMMARY

According to an aspect of the Invention, an optical transmission apparatus includes a first transmitter configured to transmit a first optical signal in a first wavelength band and a second optical signal in a second wavelength band located next to the first wavelength band; a second transmitter configured to transmit a third optical signal in a third wavelength band located next to the second wavelength band and a fourth optical signal in a fourth wavelength band located next to the third wavelength band, the third optical signal being different from the first optical signal and the fourth optical signal being different from the second optical signal; and a processor coupled to the first transmitter and the second transmitter and configured to: select the third wavelength band among the first wavelength band, the second wavelength band, the third wavelength band and the fourth wavelength band, and control the first wavelength band, the second wavelength band, and the fourth wavelength band based on the third wavelength band.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an explanatory diagram illustrating an example of an optical transmission system according to a first embodiment;

FIG. 2 is an explanatory diagram illustrating an example of arrangement of a first SC to a fourth SC in a super channel according to the first embodiment;

FIG. 3 is an explanatory diagram illustrating an example of wavelength control of the first SC and the second SC according to the first embodiment when the first SC and the second SC in a first unit in the super channel are shifted by 2 GHz in the shortest wavelength direction;

FIG. 4 is an explanatory diagram illustrating an example of arrangement of a first SC to an eighth SC in a super channel according to a second embodiment; and

FIG. 5 is an explanatory diagram illustrating an example of wavelength control of the first SC and the second SC according to the second embodiment when a first unit in the super channel is shifted by 2 GHz in the shortest wavelength direction.

### DESCRIPTION OF EMBODIMENTS

In the following, detailed descriptions will be given of an optical transmission apparatus and a wavelength control method according to embodiments of the present disclosure with reference to the drawings. In this regard, the disclosed technique is not limited by the embodiments. Also, the embodiments described below may be suitably combined within a range that does not cause a contradiction.

### First Embodiment

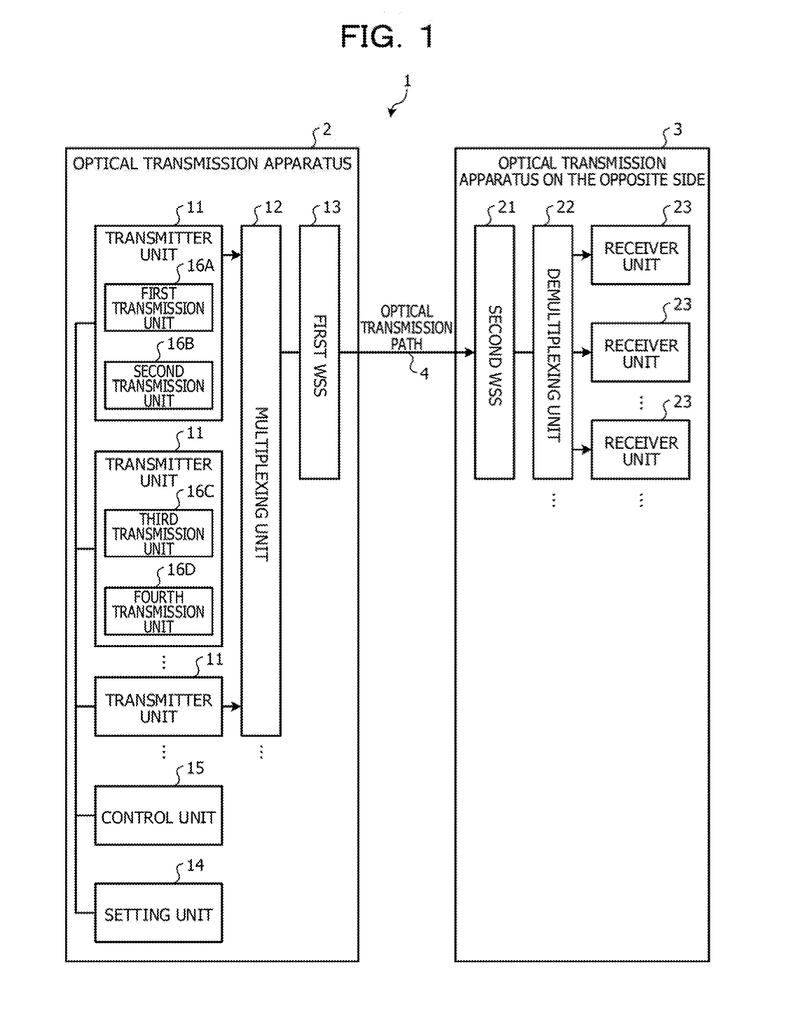

FIG. 1 is an explanatory diagram illustrating an example of an optical transmission system 1 according to a first embodiment. The optical transmission system 1 illustrated in FIG. 1 includes an optical transmission apparatus 2, an optical transmission apparatus 3 on the opposite side, and an optical transmission path 4. The optical transmission apparatus 2 includes a plurality of transmitter units 11, a multiplexing unit 12, a first WSS 13, a setting unit 14, and a control unit 15. Each of the transmitter units 11 transmits an optical signal of an SC having a light wavelength. The transmitter unit 11 includes a first transmission unit 16A and a second transmission unit 16B. The other of the transmitter units 11 includes a third transmission unit 16C and a fourth transmission unit 16D. The first transmission unit 16A transmits an optical signal of an SC having a first wavelength. The second transmission unit 16B transmits an optical signal of an SC having a second wavelength next to the first wavelength. The third transmission unit 16C transmits an optical signal of an SC having a third wavelength next to the second wavelength. The fourth transmission unit 16D transmits an optical signal of an SC having a fourth wavelength next to the third wavelength. The multiplexing unit 12 multiplexes the optical signal of the SC from each of the transmitter units 11. The first WSS 13 performs filter processing such that the optical wavelength division multiplexed signal including a plurality of SCs that have been multiplexed by the multiplexing unit 12 remains in the signal band of a super channel. The first WSS 13 then outputs the super channel having been subjected to the filter processing to the optical transmission path 4.

The setting unit 14 sets a reference SC and a control target SC from the SCs in each of the transmitter units 11. The reference SC is an SC that becomes a reference of wavelength control of the SCs in a unit. The control target SC is an SC that becomes a target of wavelength control with reference to the reference SC. The setting unit 14 sets, among a plurality of SCs in a unit in the super channel, the SC having a wavelength on the side next to the other units in the same super channel, for example, the SC having a wavelength on the side of the center wavelength λ0 of the super channel to the reference SC. Further, the setting unit 14 sets the SCs other than the reference SC in the same unit to the control target SCs. The control unit 15 controls the wavelength of the other control target SCs in the unit with reference to the reference SC for each of the transmitter units 11.

The optical transmission apparatus 3 on the opposite side includes a second WSS 21, a demultiplexing unit 22, and a plurality of receiver units 23. The second WSS 21 outputs the super channel received via the optical transmission path 4 to the demultiplexing unit 22. The demultiplexing unit 22 demultiplexes the super channel into optical signals of each SC. Each receiver unit 23 receives an optical signal corresponding to the SC that is demultiplexed by the demultiplexing unit 22.

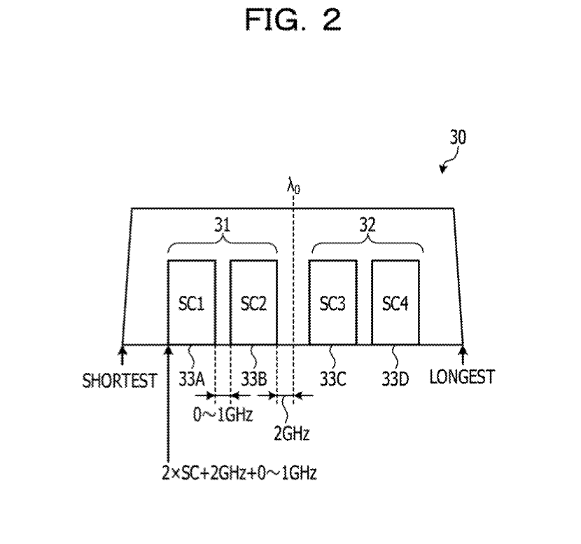

The optical transmission apparatus 2 transmits the super channel including a plurality of SCs to the optical transmission apparatus 3 on the opposite side via the optical transmission path 4. FIG. 2 is an explanatory diagram illustrating an example of arrangement of a first SC 33A to a fourth SC 33D in a super channel 30 according to the first embodiment. In the super channel 30 illustrated in FIG. 2, a first unit 31 and a second unit 32 are arranged with the center wavelength λ0 of the super channel 30 as center. The center wavelength λ0 of the super channel 30 corresponding to the center wavelength of the filter band of the first WSS 13. The first unit 31 includes the first SC 33A and the second SC 33B. The first SC 33A is an SC that was transmitted by the first transmission unit 16A. The second SC 33B is an SC that was transmitted by the second transmission unit 16B. The second unit 32 includes the third SC 33C and the fourth SC 33D. The third SC 33C is an SC that was transmitted by the third transmission unit 16C. The fourth SC 33D is an SC that was transmitted by the fourth transmission unit 16D.

The setting unit 14 sets the SC 33 having a wavelength closer to the center wavelength λ0 of the first WSS 13 among each SC 33 in the same unit 31 (32) in the super channel 30 to the reference SC. Further, the setting unit 14 sets the SC 33 other than the reference SC to the control target SC. In the first unit 31 illustrated in FIG. 2, the setting unit 14 sets the second SC 33B, which is closer to the center wavelength λ0, to the reference SC, and sets the first SC 33A to the control target SC. In the second unit 32, the setting unit 14 sets the third SC 33C, which is closer to the center wavelength λ0, to the reference SC, and sets the fourth SC 33D to the control target SC. The tolerance of the reference SC to the setting value is ±2 GHz. The control error of the wavelength control with respect to the setting value of the control target SC is 0 to 1 GHz.

The control unit 15 sets the second SC 33B, which is the reference SC in the first unit 31, to the reference in consideration of the tolerance and the control error. As illustrated in FIG. 2, the control unit 15 then controls the wavelength of the first SC 33A, which is the control target SC in the first unit 31. The control unit 15 sets the third SC 33C, which is the reference SC in the second unit 32, to the reference in consideration of the tolerance and the control error. As illustrated in FIG. 2, the control unit 15 then controls the wavelength of the wavelength of the fourth SC 33D, which is the control target SC in the second unit 32.

The maximum wavelength of the second SC 33B in the first unit 31 becomes a wavelength having an equivalent tolerance of 2 GHz from the center wavelength λ0 in the shortest wavelength direction. Further, the minimum wavelength of the first SC 33A becomes a wavelength having an equivalent tolerance of 2×SC band+2 GHz+0 to 1 GHz from the center wavelength λ0 in the shortest wavelength direction.

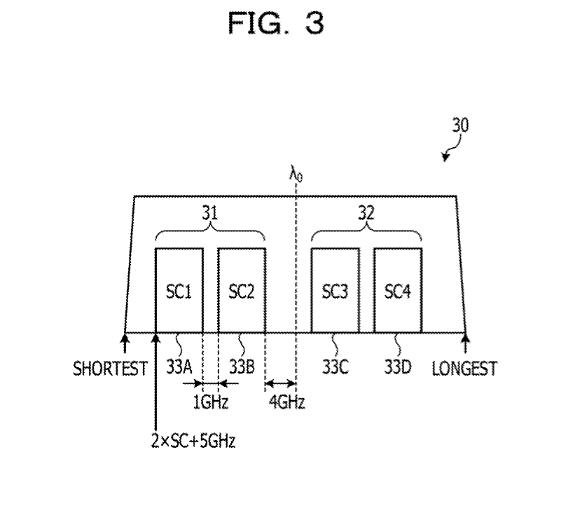

Next, a description will be given of operation of the optical transmission apparatus 2 according to the first embodiment. FIG. 3 is an explanatory diagram illustrating an example of wavelength control of the first SC 33A and the second SC 33B according to the first embodiment when the first SC and the second SC in the first unit 31 in the super channel 30 are shifted by 2 GHz in the shortest wavelength direction.

The control unit 15 controls the wavelength of the first SC 33A, which is the control target SC, with reference to the second SC 33B, which is the reference SC in the first unit 31 in consideration of the tolerance and the control error. The first SC 33A and the second SC 33B in the first unit 31 are shifted by 2 GHz in the shortest wavelength direction.

The maximum wavelength of the second SC 33B in the first unit 31 in the super channel 30 becomes an equivalent wavelength of 4 GHz from the center wavelength λ0 in the shortest wavelength direction. Even if the maximum wavelength of the first SC 33A in the first unit 31 has been shifted by 2 GHz in the shortest wavelength direction, the maximum wavelength of the first SC 33A in the first unit 31 becomes an equivalent wavelength of 2×the SC band+5 GHz from the center wavelength λ0, because the control error is 1 GHz.

Accordingly, the optical transmission apparatus 2 controlled the wavelength of the first SC 33A with reference to the second SC 33B in the case of using the second SC 33B in the first unit 31 as the reference SC, and using the first SC 33A as the control target SC. The wavelength of the first SC 33A is controlled with reference to the second SC 33B, and thus even if a shift of 2 GHz occurs in the shortest wavelength direction, the second SC 33B in the first unit 31 and the first SC 33A do not overlap. As a result, it is possible to reduce crosstalk between the first SC 33A and the second SC 33B and the PBN of the first WSS 13. It is then possible to reduce deterioration of the transmission quality of the super channel 30.

For the second unit 32, the optical transmission apparatus 2 controlled the wavelength of the fourth SC 33D with reference to the third SC 33C in the case of using the third SC 33C in the second unit 32 as the reference SC and using the fourth SC 33D as the control target SC. The wavelength of the fourth SC 33D is controlled with reference to the third SC 33C, and thus even if a shift of 2 GHz occurs in the maximum wavelength, the third SC 33C in the second unit 32 and the fourth SC 33D do not overlap. As a result, it is possible to reduce crosstalk between the third SC 33C and the fourth SC 33D and the PBN of the first WSS 13. It is then possible to reduce deterioration of the transmission quality of the super channel 30.

The super channel 30 according to the first embodiment includes two units, the first unit 31 and the second unit 32. However, the present disclosure is not limited to this configuration. For example, the super channel 30 may include four units, and it is possible to suitably change the number of units. Thus, a description will be given below of the case where the super channel including four units is applied as a second embodiment. The same symbol is given to the same component as that in the optical transmission system 1 illustrated in FIG. 1, and the description of will be omitted of the duplicated configuration and operation.

### Second Embodiment

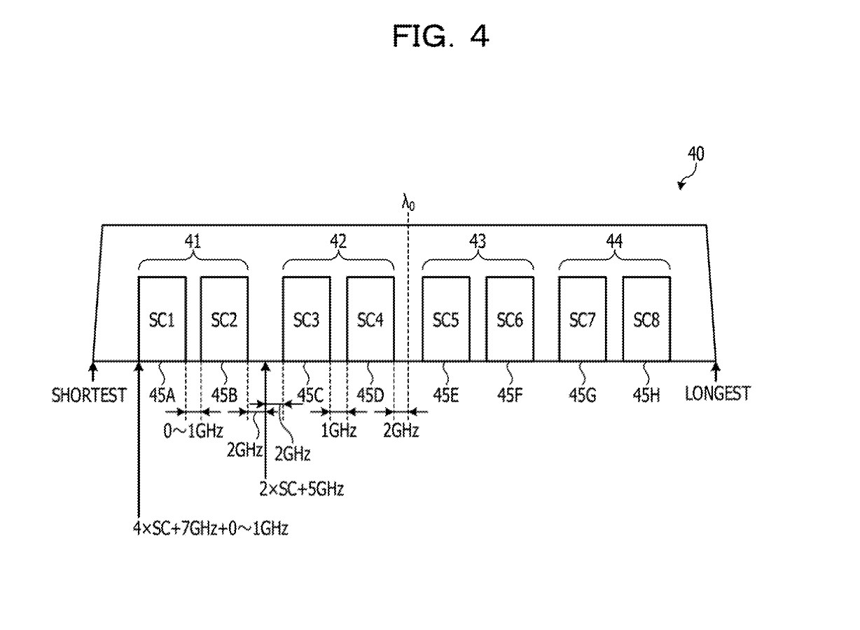

FIG. 4 is an explanatory diagram illustrating an example of arrangement of a first SC 45A to an eighth SC 45H in a super channel 40 according to the second embodiment. The super channel 40 includes a first unit 41 and a second unit 42 on one side, and a third unit 43 and a fourth unit 44 on the other side with a center wavelength λ0 as center. The first unit 41 includes a first SC 45A and a second SC45B. The second unit 42 includes a third SC 45C and a fourth SC45D. Further, the third unit 43 includes a fifth SC 45E and a sixth SC 45F. The fourth unit 44 includes a seventh SC 45G and an eighth SC 45H. In the super channel 40, the tolerance between the SCs 45 is ±2 GHz, and the control error is 0 to 1 GHz.

The setting unit 14 sets the second SC 45B having a wavelength closer to the center wavelength λ0 in the first unit 41 to the reference SC, and sets the first SC 45A to the control target SC. The setting unit 14 sets the fourth SC 45D having a wavelength closer to the center wavelength λ0 in the second unit 42 to the reference SC, and sets the third SC 45C to the control target SC. The setting unit 14 sets the fifth SC 45E having a wavelength closer to the center wavelength λ0 in the third unit 43 to the reference SC, and sets the sixth SC 45F to the control target SC. The setting unit 14 sets the seventh SC 45G having a wavelength closer to the center wavelength λ0 in the fourth unit 44 to the reference SC, and sets the eighth SC 45H to the control target SC.

The control unit 15 controls the wavelength of the first SC 45A with reference to the second SC 45B in the first unit 41. Further, the control unit 15 controls the wavelength of the third SC 45C with reference to the fourth SC 45D in the second unit 42. As a result, the minimum wavelength of the fourth SC 45D in the second unit 42 becomes an equivalent wavelength having a tolerance of 2 GHz in the shortest wavelength direction from the center wavelength λ0. The interval between the fourth SC 45D and the third SC 45C is 1 GHz. The minimum wavelength of the third SC 45C becomes the SC band×2+a tolerance of 2 GHz+a control error of 1 GHz, that is to say, an equivalent wavelength of the SC band×2+5 GHz from the center wavelength λ0 in the shortest wavelength direction. Further, the maximum wavelength of the second SC 45B in the first unit 41 becomes an equivalent wavelength of 2×SC band+3 GHz+a tolerance of 2 GHz+a tolerance of 2 GHz from the center wavelength λ0 in the shortest wavelength direction. The Interval between the first SC 45A and the second SC 45B is from 0 to 1 GHz. The minimum wavelength of the first SC 45A becomes an equivalent wavelength of 4×SC band+7 GHz+a control error of 0 to 1 GHz from the center wavelength λ0 in the shortest wavelength direction.

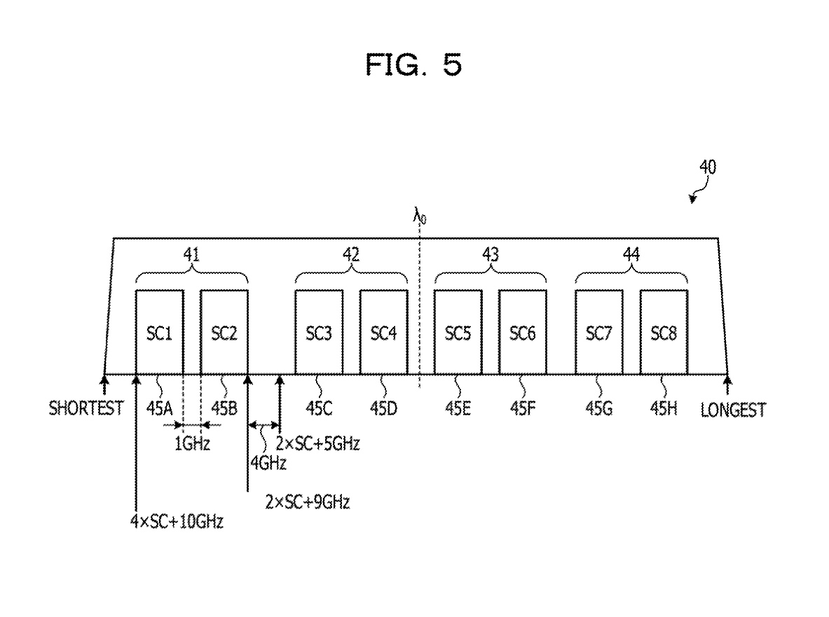

Next, a description will be given of operation of the optical transmission apparatus 2 according to the second embodiment. FIG. 5 is an explanatory diagram illustrating an example of wavelength control of the first SC 45A and the second SC 45B according to the second embodiment when the first SC 45A and the second SC 45B in the first unit 41 in the super channel 40 are shifted by 2 GHz in the shortest wavelength direction. The control unit 15 controls the wavelength of the first SC 45A, which is the control target SC with reference to the second SC 45B, which is the reference SC in the first unit 41, in consideration of the tolerance and the control error. The first SC 45A and the second SC 45B are shifted by 2 GHz in the shortest wavelength direction.

The maximum wavelength of the second SC 45B in the first unit 41 in the super channel 40 becomes an equivalent wavelength of 2×SC band+5 GHz+a tolerance of 2 GHz+the amount of shift, 2 GHz, that is to say, 2×SC band+9 GHz from the center wavelength λ0. Even if a shift of 2 GHz in the shortest wavelength direction occurs, the maximum wavelength of the first SC 45A in the first unit 41 becomes an equivalent wavelength of 4×SC band+10 GHz from the center wavelength λ0 because the control error is 1 GHz.

Accordingly, the optical transmission apparatus 2 controlled the wavelength of the first SC 45A with reference to the second SC 45B in the case of using the second SC 45B in the first unit 41 as the reference SC, and using the first SC 45A as the control target SC. The wavelength of the first SC 45A is controlled with reference to the second SC 45B, and thus even if a shift of 2 GHz occurs in the shortest wavelength direction, the second SC 45B in the first unit 41 and the first SC 45A do not overlap. As a result, it is possible to reduce the crosstalk between the first SC 45A and the second SC 45B and the PBN. It is then possible to reduce deterioration of the transmission quality of the super channel 40.

For the second unit 42, the optical transmission apparatus 2 controlled the wavelength of the fourth SC 45D with reference to the third SC 45C in the case of using the fourth SC 45D in the second unit 42 as the reference SC, and using the third SC 45C as the control target SC. The wavelength of the fourth SC 45D is controlled with reference to the third SC 45C, and thus even if a shift of 2 GHz occurs in the shortest wavelength direction, the third SC 45C in the second unit 42 and the fourth SC 45D do not overlap. As a result, it is possible to reduce the crosstalk between the third SC 45C and the fourth SC 45D and the PBN. It is then possible to reduce deterioration of the transmission quality of the super channel 40.

For the third unit 43, the optical transmission apparatus 2 controlled the wavelength of the sixth SC 45F with reference to the fifth SC 45E in the case of using the fifth SC 45E in the third unit 43 as the reference SC, and using the sixth SC 45F as the control target SC. The wavelength of the sixth SC 45F is controlled with reference to the fifth SC 45E, and thus even if a shift of 2 GHz occurs in the maximum wavelength, the fifth SC 45E in the third unit 43 and the sixth SC 45F do not overlap. As a result, it is possible to reduce the crosstalk between the fifth SC 45E in the third unit 43 and the sixth SC 45F and the PBN. It is then possible to reduce deterioration of the transmission quality of the super channel 40.

Further, for the fourth unit 44, the optical transmission apparatus 2 controlled the wavelength of the eighth SC 45H with reference to the seventh SC 45G in the case of using the seventh SC 45G in the fourth unit 44 as the reference SC, and using the eighth SC 45H as the control target SC. The wavelength of the eighth SC 45H is controlled with reference to the seventh SC 45G, and thus even if a shift of 2 GHz occurs in the maximum wavelength, the seventh SC 45G in the fourth unit 44 and the eighth SC 45H do not overlap. As a result, it is possible to reduce the crosstalk between the seventh SC 45G in the fourth unit 44 and the eighth SC 45H and the PBN. It is then possible to reduce deterioration of the transmission quality of the super channel 40.

In the first embodiment and the second embodiment, the examples of the case in which one unit includes two SCs are illustrated. However, three or more SCs may be included in one unit. In this case, among a plurality of SCs in the unit, the SC having a wavelength closer to the center wavelength λ0 is set to the reference SC, and the other SCs are set to the control target SCs. In the first embodiment and the second embodiment, among a plurality of SCs in the unit, the SC having the wavelength closest to the center wavelength λ0 of the super channel is set to the reference SC. However, the present disclosure is not limited to this, and it is possible to set an SC having the wavelength other than the farthest from the center wavelength λ0 to the reference SC among a plurality of SCs in the unit.

In the first embodiment and the second embodiment, among a plurality of SCs in a unit in the super channel, the SC having a wavelength closest to the center wavelength λ0 of the super channel is set to the reference SC, and the SCs other than the reference SC is set to the control target SCs. As a result, the reference SC and the control target SCs do not overlap, and thus it is possible to reduce the crosstalk between the SCs in the unit and the occurrence of the PBN. It is then possible to reduce deterioration of the transmission quality of the super channel.

In the above-described embodiments, the first transmission unit 16A and the second transmission unit 16B are included in one of the transmitter units 11, and the third transmission unit 16C and the fourth transmission unit 16D are included in the other of the transmitter units 11. However, the present disclosure is not limited to these, and it is possible to suitably change the configuration. For example, each transmitter unit 11 may include one transmission unit or three or more transmission units.

All of or any one of the various processing functions performed by each apparatus may be executed on a central processing unit (CPU) (or a microcomputer, such as a micro processing unit (MPU), a micro controller unit (MCU), or the like). All of or any one of the various processing functions may be performed by a program that is analyzed and executed by the CPU (or the microcomputer, such as the MPU, the MCU, or the like), or by hardware based on wired logic as a matter of course.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and Inferiority of the invention. Although the embodiments of the present invention have been described in detail, it should be understood that the various changes, substitutions, and alterations could be made hereto without departing from the spirit and scope of the invention.

What is claimed is:

1. An optical transmission apparatus, comprising:
a first transmitter configured to transmit a first optical signal in a first wavelength band and a second optical signal in a second wavelength band located next to the first wavelength band;
a second transmitter configured to transmit a third optical signal in a third wavelength band located next to the second wavelength band and a fourth optical signal in a fourth wavelength band located next to the third wavelength band, the third optical signal being different from the first optical signal and the fourth optical signal being different from the second optical signal; and
a processor coupled to the first transmitter and the second transmitter and configured to:
select the third wavelength band among the first wavelength band, the second wavelength band, the third wavelength band and the fourth wavelength band, and
control the first wavelength band, the second wavelength band, and the fourth wavelength band based on the third wavelength band.

2. The optical transmission apparatus according to claim 1,
wherein the processor is configured to change an interval of the first wavelength band and the second wavelength band, and an interval of the third wavelength band and the fourth wavelength band, based on the third wavelength band.

3. The optical transmission apparatus according to claim 1, wherein
the first transmitter transmits the first optical signal having the first wavelength band controlled by the processor and the second optical signal having the second wavelength band controlled by the processor, and
the second transmitter transmits the third optical signal having the third wavelength band controlled by the processor and the fourth optical signal having the fourth wavelength band controlled by the processor.

4. The optical transmission apparatus according to claim 1,
wherein the third wavelength band is located at a center of the distribution of the first wavelength band, the second wavelength band, the third wavelength band, and the fourth wavelength band among the first wavelength band, the second wavelength band, the third wavelength band, and the fourth wavelength band.

5. The optical transmission apparatus according to claim 4, wherein
the first wavelength band is a band including a wavelength shorter than a wavelength of the second wavelength band,
the second wavelength band is a band including a wavelength shorter than the center wavelength,
the third wavelength band is a band including a wavelength longer than a wavelength of the center wavelength, and
the fourth wavelength band is a band including a wavelength longer than the wavelength of the third wavelength band.

6. The optical transmission apparatus according to claim 1, further comprising:
a multiplexer configured to multiplex the first optical signal, the second optical signal, the third optical signal, and the fourth optical signal to generate an optical wavelength division multiplexed signal; and
a wavelength selection switch coupled to the multiplexer and configured to filter the optical wavelength division multiplexed signal to generate a super channel, and output the generated super channel.

7. A wavelength control method executed by an optical transmission apparatus including a first transmitter, a second transmitter, and a processor, the wavelength control method comprising:
among a first wavelength band of a first optical signal, a second wavelength band located next to the first wavelength band of a second optical signal, a third wavelength band located next to the second wavelength band of a third optical signal, a fourth wavelength band located next to the third wavelength band of a fourth optical signal, selecting the third wavelength band by the processor, wherein the third optical signal is different from the first optical signal and the fourth optical signal is different from the second optical signal,
controlling the first wavelength band, the second wavelength band, and the fourth wavelength band based on the reference band,
transmitting by the first transmitter the first optical signal having the first wavelength band controlled by the processor, and the second optical signal having the second wavelength band controlled by the processor, and
transmitting by the second transmitter the third optical signal having the third wavelength band controlled by the processor, and the fourth optical signal having the fourth wavelength band controlled by the processor.

8. The wavelength control method according to claim 7,
wherein the controlling includes changing an interval of the first wavelength band and the second wavelength band, and an interval of the third wavelength band and the fourth wavelength band, based on the third wavelength band.

9. The wavelength control method according to claim 7,
wherein the third wavelength band is located at a center of the distribution of the first wavelength band, the second wavelength band, the third wavelength band, and the fourth wavelength band among the first wavelength band, the second wavelength band, the third wavelength band, and the fourth wavelength band.

10. The wavelength control method according to claim 9,
wherein the first wavelength band is a band including a wavelength shorter than a wavelength of the second wavelength band,
the second wavelength band is a band including a wavelength shorter than the center wavelength,
the third wavelength band is a band including a wavelength longer than a wavelength of the center wavelength, and
the fourth wavelength band is a band including a wavelength longer than the wavelength of the third wavelength band.
